(19) United States
(12) Patent Application Publication
(10) Pub. No.: US 2015/0009427 A1
(43) Pub. Date: Jan. 8, 2015

(54) TOUCH PANEL

(71) Applicants: Chien-Chung Chen, Taichung City (TW); Yi-Shu Chen, Taichung City (TW); Hen-Ta Kang, Taichung City (TW); Chong-Wei Li, Changhua County (TW)

(72) Inventors: Chien-Chung Chen, Taichung City (TW); Yi-Shu Chen, Taichung City (TW); Hen-Ta Kang, Taichung City (TW); Chong-Wei Li, Changhua County (TW)

(73) Assignee: WINTEK CORPORATION, Taichung City (TW)

(21) Appl. No.: 14/324,083

(22) Filed: Jul. 4, 2014

(30) Foreign Application Priority Data
Jul. 5, 2013 (TW) 102124199

(51) Int. Cl. G06F 3/041

(52) U.S. Cl. CPC G06F 3/041
USPC 349/12

(57) ABSTRACT

A touch panel includes a substrate, a plurality of first touch-sensing units, and a plurality of first optical mesh patterns. The first touch-sensing units electrically insulated from each other or one another are located on the substrate. Each of the first touch-sensing units includes a plurality of first mesh patterns connected together. The first optical mesh patterns are located on the substrate. Besides, the first optical mesh patterns are overlapped with the first mesh patterns and located on a surface of the first mesh patterns adjacent to a user.

### CROSS-REFERENCE TO RELATED APPLICATION

This application claims the priority benefit of Taiwan application serial no. 102124199, filed on Jul. 5, 2013. The entirety of the above-mentioned patent application is hereby incorporated by reference herein and made a part of this specification.

### BACKGROUND OF THE INVENTION

1. Field of the Invention

The invention relates to a panel. More particularly, the invention relates to a touch panel.

2. Description of Related Art

Information technologies (ITs), wireless mobile communications, and information home appliances have been rapidly developed and widely applied. To meet current demands for portable, compact, and user-friendly IT products, touch panels have been introduced as input devices in replacement of conventional keyboards or mice.

Touch panels are generally categorized into capacitive touch panels and resistive touch panels. The capacitive touch panel usually includes a plurality of touch-sensing units. At present, the touch-sensing units on the market are often made of indium-tin oxide (ITO). Indium, however, is one of the rare metals; therefore, indium is likely to be subject to the place of origin and is difficult to obtain. In addition, indium is rather expensive, such that the manufacturing costs of the resultant touch panel cannot be reduced, which is detrimental to commercial competitiveness.

In recent years, touch-sensing units made of mesh metal rather than ITO have been developed. The metal material is easy to acquire and is characterized by favorable conductivity and thus has been played a conspicuous role in the industry. Nevertheless, the mesh metal still encounters the issue of high reflectivity. Accordingly, the way to enhance the visual effects of the touch panel without compromising the advantages of mesh metal will be the general course of future development.

### SUMMARY OF THE INVENTION

The invention is directed to a touch panel capable of accomplishing exceptional visual effects.

In an embodiment of the invention, a touch panel that includes a substrate, a plurality of first touch-sensing units, and a plurality of first optical mesh patterns is provided. The first touch-sensing unit electrically insulated from each other or one another are located on the substrate, and each of the first touch-sensing unit includes a plurality of first mesh patterns connected together. The first optical mesh patterns are located on the substrate. Besides, the first optical mesh patterns are overlapped with the first mesh patterns and located on a surface of the first mesh patterns adjacent to a user.

In an embodiment of the invention, a touch panel that includes a substrate, a plurality of first optical mesh patterns, and a plurality of first touch-sensing units is provided. The first optical mesh patterns are located on the substrate. The first touch-sensing units are electrically insulated from each other or one another and are located on the substrate. Each of the first touch-sensing units includes a plurality of first mesh patterns overlapped with the first optical mesh patterns and at least one first mesh pattern not overlapped with the first optical mesh patterns, and the first optical mesh patterns are located on a surface of the first mesh patterns adjacent to a user.

In view of the above, the touch-sensing units of the touch panel described herein are constituted by the metal mesh patterns, and the optical mesh patterns overlapped with the mesh patterns are configured on the surface of the mesh patterns adjacent to the user. Thereby, the issue of high reflectivity along a view direction in the region where the mesh patterns are located may be resolved, so as to ensure the outstanding visual effects of the touch panel.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1A is a schematic top view illustrating a touch panel according to a first embodiment of the invention.

FIG. 1B is a schematic cross-sectional view taken along a sectional line A-A′ in FIG. 1A.

FIG. 2A is a schematic partial top view illustrating a touch panel according to a second embodiment of the invention.

FIG. 2B is a schematic enlarged partial view of FIG. 2A.

FIG. 2C is a schematic cross-sectional view taken along a sectional line B-B′ in FIG. 2B.

FIG. 3A is a schematic partial top view illustrating a touch panel according to a third embodiment of the invention.

FIG. 3B is a schematic cross-sectional view taken along a sectional line C-C′ in FIG. 3A.

FIG. 4 is a schematic partial cross-sectional view illustrating a touch panel according to a fourth embodiment of the invention.

FIG. 5 is a schematic partial cross-sectional view illustrating a touch panel according to a fifth embodiment of the invention.

FIG. 6 is a schematic partial cross-sectional view illustrating a touch panel according to a sixth embodiment of the invention.

FIG. 7 is a schematic partial cross-sectional view illustrating a touch panel according to a seventh embodiment of the invention.

### DETAILED DESCRIPTIONS OF EMBODIMENTS

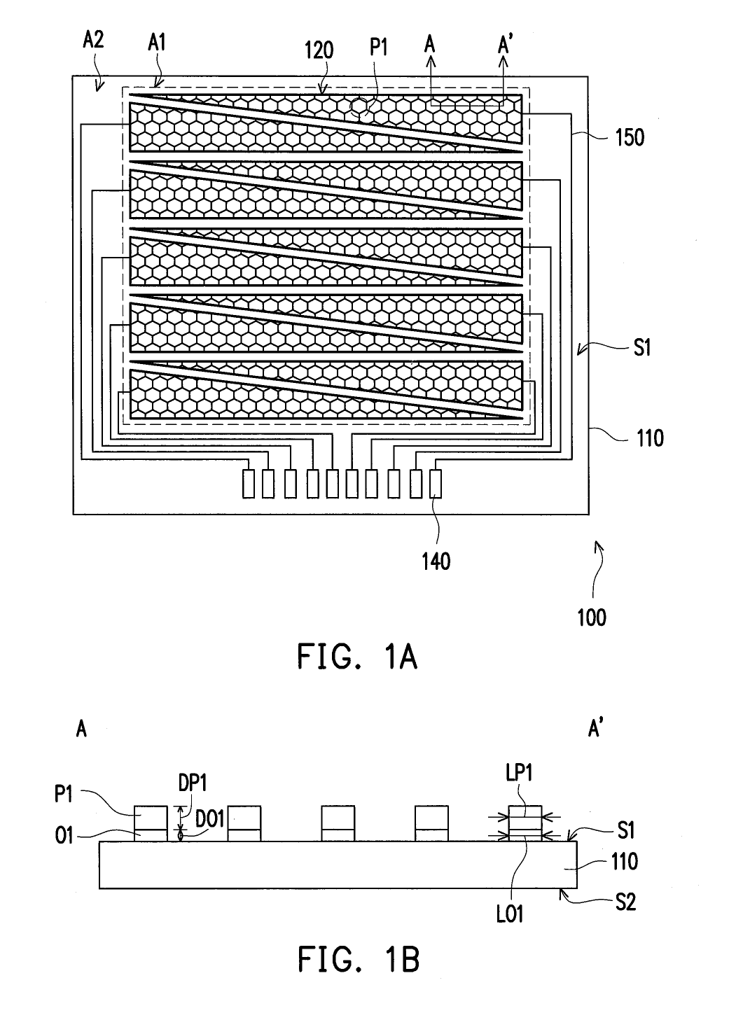

FIG. 1A is a schematic top view illustrating a touch panel according to a first embodiment of the invention. FIG. 1B is a schematic cross-sectional view taken along a sectional line A-A′ in FIG. 1A. With reference to FIG. 1A and FIG. 1B, the touch panel 100 described in the present embodiment includes a substrate 110, a plurality of first touch-sensing units 120 electrically insulated from each other or one another, and a plurality of first optical mesh patterns O1 (shown in FIG. 1B). The first touch-sensing units 120 and the first optical mesh patterns O1 are located on the substrate 110.

Specifically, the substrate 110 includes a touch area A1 and a peripheral area A2 located around the touch area A1, and the first touch-sensing units 120 and the first optical mesh patterns O1 are located in the touch area A1. In the present embodiment, the touch panel 100 may further include a plurality of bonding pads 140, a plurality of traces 150, and a decoration layer (not shown). The bonding pads 140, the traces 150, and the decoration layer are located on the substrate 110 and in the peripheral area A2, and the first touch-sensing units 120 are electrically connected to the bonding pads 140 through the traces 150. The decoration layer is, for instance, an ink layer or a photoresist layer and is suitable for covering the bonding pads 140 and the traces 150.

It should be mentioned that the first touch-sensing units 120 in another embodiment may be extended into the peripheral area A2 and connected to the traces 150. Alternatively, when the touch panel described herein is applied in a touch display panel, and the touch display panel has the function keys in the peripheral area A2, the first touch-sensing units 120 may be further configured at the locations corresponding to the function keys in the peripheral area A2, such that the function keys are capable of being activated by touch actions.

In the present embodiment, the first touch-sensing units 120, the bonding pads 140, the traces 150, and the first optical mesh patterns O1 are located on the same surface S1 of the substrate 110 but may not be in direct contact with the surface S1. For instance, one single inorganic film layer or a composite inorganic film layer acting as a buffer layer or an index-match layer may be optionally configured between the surface S1 and said film layers. The inorganic film layer may be silicon nitride, silicon oxide, or a composite film layer containing silicon nitride and silicon oxide. The index-match layer may be constituted by multiple film layers with different refractive indices, e.g., the index-match layer may be constituted by a first film layer with a first refractive index and a second film layer with a second refractive index greater than the first refractive index. It is also likely to move the index-match layer to be located above the first touch-sensing units 120, so as to completely or partially cover the first touch-sensing units 120. Here, the index-match layer may serve as a protection layer. Certainly, the index-match layer may be located above and below the first touch-sensing units 120 at the same time.

In the present embodiment, the first touch-sensing units 120, the bonding pads 140, and the traces 150 are formed by one conductive layer, for instance. Particularly, the first touch-sensing units 120, the bonding pads 140, and the traces 150 are made by forming a material of said conductive layer on the surface S1 of the substrate 110 and forming the first touch-sensing units 120, the bonding pads 140, and the traces 150 through performing a patterning process, for instance. The material of the conductive layer exemplarily includes copper, silver, aluminum, chromium, titanium, molybdenum, or an alloy having at least two of the above.

Since the bonding pads 140, the traces 150, and the first touch-sensing units 120 described herein are made of the same material other than ITO, the first touch-sensing units 120 are not only characterized by favorable conductivity but also able to be patterned together with the bonding pads 140 and the traces 150. Thereby, the overall manufacture of the touch panel 100 may be simplified. Moreover, the material of the conductive layer is employed to make the first touch-sensing units 120 in the touch panel 100 to replace the transparent conductive material including rare metal (indium), and thus the manufacturing costs of the touch panel 100 described herein may be reduced.

In another aspect, the first touch-sensing units 120 described herein are made of metal with low transmissivity; therefore, the first touch-sensing units 120 are designed to be constituted by first mesh patterns P1 that are connected together, so as to increase the transmissivity of the first touch-sensing units 120. Here, a shape of each of the first mesh patterns P1 may include a circular shape, a polygonal shape, a sine-wave shape, a curve, or a combination of two of the above. For instance, each of the first mesh patterns P1 may be shaped as a hexagon, which should however not be construed as a limitation to the invention.

In addition, to reduce the visibility of the profile of each of the first mesh patterns P1 to human eyes, a line width LP1 of each of the first mesh patterns P1 described in the present embodiment is equal to or smaller than 20 micrometers, for instance. Besides, in consideration of the conductivity and the stress of the first mesh patterns P1, a thickness DP1 of each of the first mesh patterns P1 substantially ranges from 10 nanometers to 15 micrometers, for instance.

To clearly illustrate the first mesh patterns P1, the proportion of the first mesh patterns P1 to the first touch-sensing units 120 is intentionally changed in FIG. 1A. Practically, the size of each first mesh pattern P1 may be determined according to actual design requirements. For instance, the size of each of the first mesh patterns P1 may range from 50 micrometers to 300 micrometers.

Due to the high reflectivity of the first mesh patterns P1 made of metal, light is apt to be reflected in the region where the first mesh patterns P1 are located, which accordingly poses a negative impact on the visual effects of the touch panel 100. For instance, bright spots or color aberration may be observed in the region where the first mesh patterns P1 are located. To resolve the issue of high reflectivity along a view direction in the region where the first mesh patterns P1 are located, the first optical mesh patterns O1 are overlapped with the first mesh patterns P1, and the first optical mesh patterns O1 are located on a surface of the first mesh patterns P1 adjacent to the user. Here, a thickness DO1 of the first optical mesh patterns O1 substantially ranges from 3 nanometers to 500 nanometers, for instance.

In the present embodiment, the substrate 110 is, for instance, a cover lens, and a surface S2 of the substrate 110 opposite to the surface S1 where said components are located is a touch surface of the touch panel 100, for instance. Hence, the first optical mesh patterns O1 described herein are located between the first mesh patterns P1 and the substrate 110. In another embodiment, if the surface S1 is the touch surface, the first optical mesh patterns O1 are located on one side of the first mesh patterns P1 away from the substrate 110, i.e., the first mesh patterns P1 are located between the first optical mesh patterns O1 and the substrate 110. The substrate 110 may also be a color filter substrate of a liquid crystal display (LCD) or an encapsulation cover plate of an organic light-emitting diode (OLED). If the first mesh patterns P1 are located on an outer surface of the substrate 110 (i.e., the surface S2 of the substrate 110 opposite to the surface where said components are located), the first mesh patterns P1 are located between the first optical mesh patterns 01 and the substrate 110. By contrast, if the first mesh patterns P1 are located on an inner surface of the substrate 110 (i.e., the surface S1 of the substrate 110 where said components are located), the first optical mesh patterns O1 are located between the first mesh patterns P1 and the substrate 110.

According to the present embodiment, a profile of each of the first optical mesh patterns O1 is substantially the same as a profile of each of the first mesh patterns P1. That is, a line width LO1 of each of the first optical mesh patterns O1 is equal to the line width LP1 of each of the first mesh patterns P1, for instance, and the sidewall of each of the first optical mesh patterns O1 is aligned to the sidewall of each of the first mesh patterns P1, for instance. However, the invention is not limited thereto. In another embodiment of the invention, the visibility of the first mesh patterns P1 to human eyes along a side-view direction may be reduced by properly changing the line width LO1 of each of the first optical mesh patterns O1, e.g., by modifying the line width LO1 of each of the first optical mesh patterns O1 to be greater than the line width LP1 of each of the first mesh patterns P1. The visibility of the first mesh patterns P1 to human eyes along the side-view direction may also be reduced by adjusting the thickness DO1 of each of the first optical mesh patterns O1. If the line width LO1 is greater than the line width LP1, and if the surface S1 serves as the touch surface, the first mesh patterns P1 are located between the first optical mesh patterns O1 and the substrate 110, and thus the first mesh patterns P1 are covered.

Note that the first optical mesh patterns O1 and the first mesh patterns P1 may not be completely overlapped. For instance, in an embodiment of the invention, most of the first mesh patterns P1 are overlapped with the first optical mesh patterns O1, while the residual first mesh patterns are not overlapped with the first optical mesh patterns O1. Besides, the region of the first mesh patterns P1 where the first mesh patterns P1 are overlapped with the first optical mesh patterns O1 accounts for at least 90% of the entire region occupied by the first mesh patterns P1. Namely, each of the first touch-sensing units 120 may include a plurality of first mesh patterns P1 overlapped with the first optical mesh patterns O1 and at least one first mesh pattern P1 not overlapped with the first optical mesh patterns O1, which still falls within the scope of protection of the invention. Besides, if the first mesh patterns P1 are extended from the touch area A1 to the peripheral area A2, it is likely not to form the first optical mesh patterns O1 in a region of the peripheral area A2 where the first mesh patterns P1 are located. Alternatively, in the event that other components may serve to cover the first mesh patterns P1, it is likely not to form the first optical mesh patterns O1 in a region where the first mesh patterns P1 are located.

According to the present embodiment, the first optical mesh patterns O1 may be made of a material with a high extinction coefficient (i.e., high light-absorption rate) or a high refractive index, so as to resolve the issue of high reflectivity in the region where the first mesh patterns P1 are located.

For instance, the material of the first optical mesh patterns O1 with the high extinction coefficient may be copper oxide, chromium oxide, titanium oxide, molybdenum oxide, or a stacked layer having at least two of the above. Besides, the first optical mesh patterns O1 and the first mesh patterns P1 may be formed by sputtering. In an embodiment of the invention, if the first optical mesh patterns O1 are made of an oxide of the material of the first mesh patterns P 1, the first optical mesh patterns O1 and the first mesh patterns P1 may be completed by changing the oxygen flux during the sputtering process. Additionally, through adjusting the thickness DO1 of each of the first optical mesh patterns, the first mesh patterns P1 and the first optical mesh patterns O1 may be patterned through one etching process. However, the material of the first optical mesh patterns O1 is not limited to be the oxide of the material of the first mesh patterns P1 in the invention. The manufacturing method of the first optical mesh patterns O1 and the first mesh patterns P1 should also not be construed as a limitation to the invention.

The first mesh patterns P1 and the first optical mesh patterns O1 may be formed by sputtering under a low-temperature environment, and therefore the selection of the material of the substrate 110 may be less subject to the manufacturing temperature. For instance, the substrate 110 may be made of glass, sapphire, quartz, an organic polymer, or any other appropriate material.

In the previous embodiment, the first optical mesh patterns O1 may be made of metal oxide with the high extinction coefficient; in other embodiments, the first optical mesh patterns O1 may also be made of chromium, nickel, molybdenum, titanium, or an alloy having at least two of the above. The first optical mesh patterns O1 may be made of a resin light-absorption material or a carbon-black paint as well. In case that the first optical mesh patterns O1 are made of a material with the high refractive index (e.g., substantially ranging from 1.6 to 2.4), the first optical mesh patterns O1 may be made of titanium dioxide, silicon oxide, silicon nitride, silicon oxynitride, silicon aluminum oxide, or a stacked layer having at least two of the above for example. Through the destructive interference of light at the first optical mesh patterns O1, the issue of high reflectivity in the region where the first mesh patterns P1 are located may also be resolved.

Note that said design concept of the first optical mesh patterns O1 and the first mesh patterns P1 may also be applied to design other components of the touch panel. For instance, if the traces 150 are extended into the touch area A1, or if the traces 150 are initially arranged in the touch area A1, optical patterns may be configured on a surface of the traces 150 in the touch area A1, and the surface is adjacent to a user. Thereby, the issues of high reflectivity in the region of the touch area A1 where the traces 150 are located may be resolved. Said issues may include the bright spots in the region with high reflectivity and the visible color aberration between the colored first mesh patterns P1 and the substrate 110.

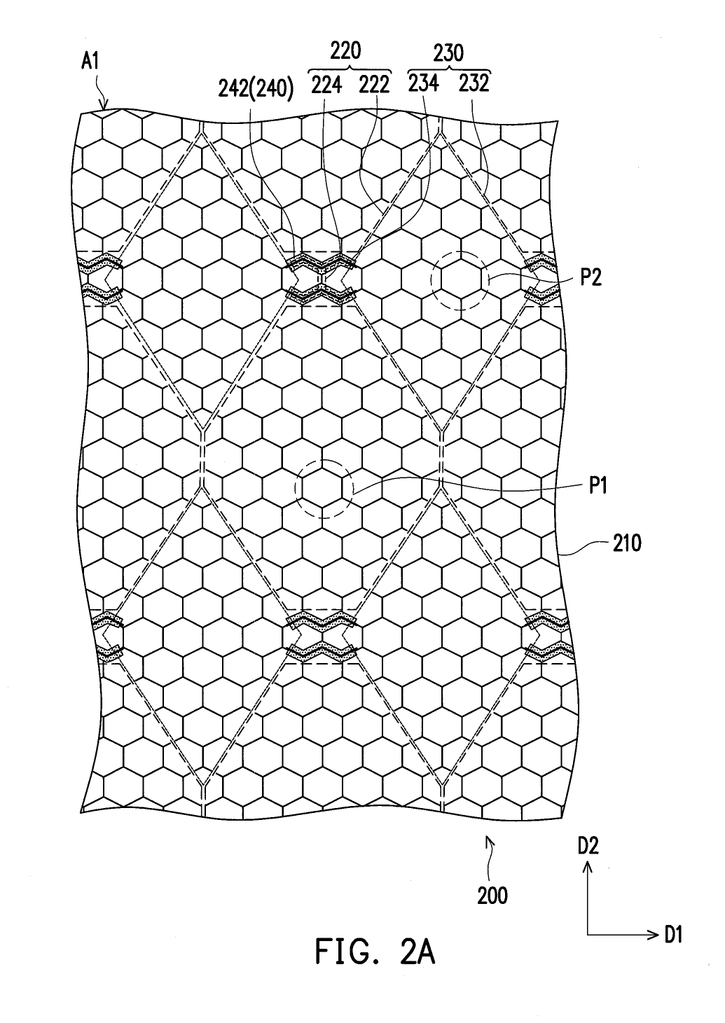

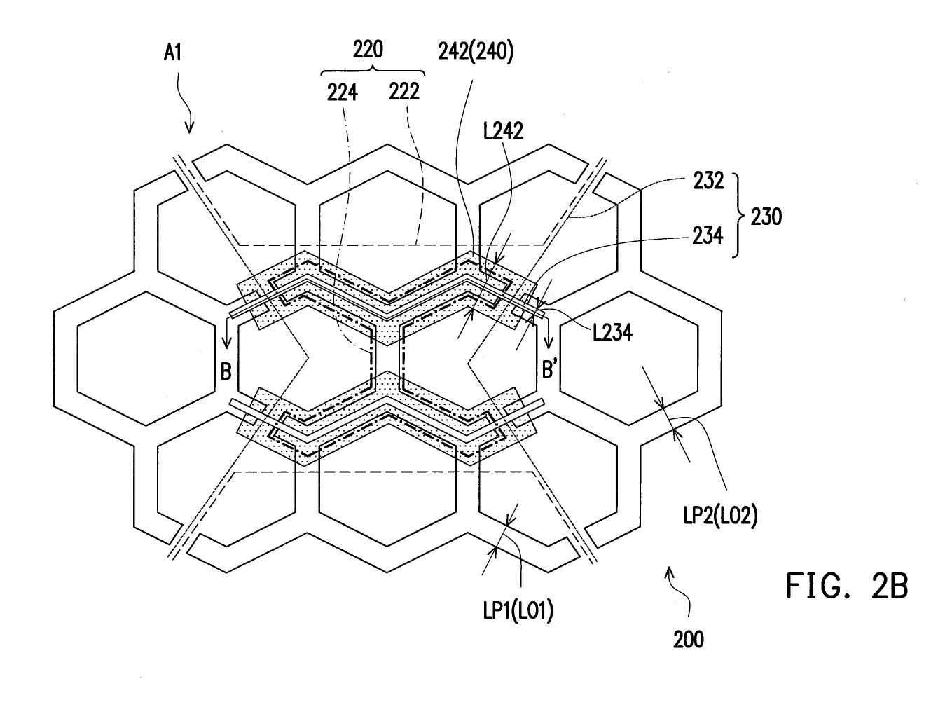

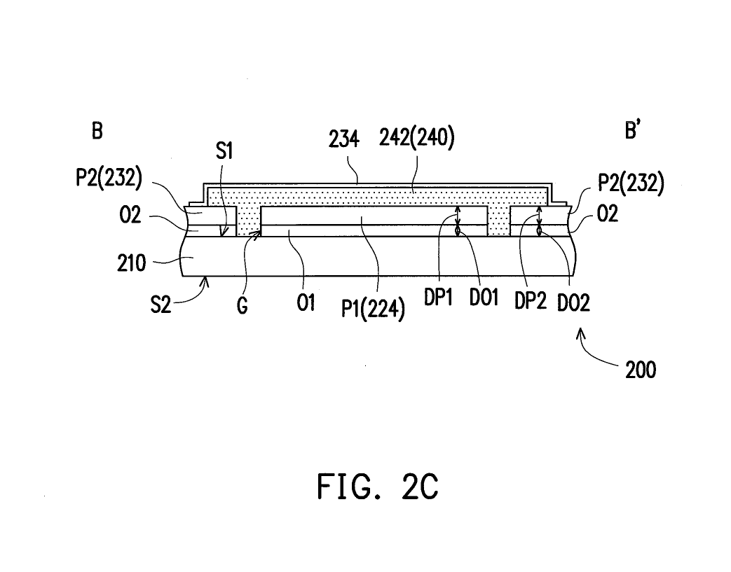

FIG. 2A is a schematic partial top view illustrating a touch panel according to a second embodiment of the invention. To clearly show the touch-sensing units in the present embodiment, the bonding pads and the traces are omitted in FIG. 2A. FIG. 2B is a schematic enlarged partial view of FIG. 2A. FIG. 2C is a schematic cross-sectional view taken along a sectional line B-B′ in FIG. 2B. With reference to FIG. 2A to FIG. 2C, the components as well as their relative arrangements, thicknesses, line widths, and materials described in the touch panel 200 are similar to those provided in the touch panel 100. Particularly, the relative arrangements, thicknesses, line widths, and materials of the substrate 210, the first touch-sensing units 220, and the first optical mesh patterns O1 in the touch panel 200 may be referred to as those described above and thus will not be further explained.

The difference between the touch panel 100 and the touch panel 200 mainly lies in that the touch panel 200 described in the present embodiment further includes a plurality of second touch-sensing units 230 electrically insulated from each other or one another, an insulation layer 240, and a plurality of second optical mesh patterns O2 (the configurations of the second optical mesh patterns O2 will be provided later, as shown in FIG. 2C). Besides, the second touch-sensing units 230, the insulation layer 240, the second optical mesh patterns O2, the first touch-sensing units 220, and the first optical mesh patterns O1 are located on the same surface S1 of the substrate 210, for instance.

Specifically, the substrate 210 includes a touch area A1 and a peripheral area (not shown) located around the touch area A1, and the first touch-sensing units 220, the first optical mesh patterns O1, the second touch-sensing units 230, the insulation layer 240, and the second optical mesh patterns O2 are located in the touch area A1. It is likely to place a plurality of bonding pads (not shown) in the peripheral area. The first touch-sensing units 220 are electrically connected to the bonding pads (not shown) through some traces (not shown), and the second touch-sensing units 230 are electrically connected to the bonding pads (not shown) through other traces (not shown). The descriptions of the bonding pads and the traces that are not shown herein may be referred to as those in the first embodiment. Here, one end of each trace is electrically connected to one of the bonding pads, and the other end of each trace is electrically connected to one of the first and second touch-sensing units 220 and 230. It is also possible to place a decoration layer (not shown) in the peripheral area A2 according to the present embodiment, so as to cover the bonding pads and the traces.

In the present embodiment, the first touch-sensing units 220 are arranged along a first direction D1 and individually extended along a second direction D2, and the second direction D2 intersects the first direction D1. Here, the second direction D2 is perpendicular to the first direction D1, for instance, while the invention is not limited thereto. Each of the first touch-sensing units 220 includes a plurality of first sub-units 222 and a plurality of connection portions 224, and two adjacent first sub-units 222 are serially connected by the connection portions 224 along the second direction D2.

In the present embodiment, each of the first touch-sensing units 220 is comprised of a plurality of first mesh patterns P1, so as to enhance the light transmissivity of the first touch-sensing units 220. The shape of the first mesh patterns P1 may be the shape described in the previous embodiment. For instance, each of the first mesh patterns P1 may be shaped as a hexagon.

In the present embodiment, each first sub-unit 222 is shaped as an octagon similar to a rhombus and is constituted by a plurality of complete first mesh patterns P1 and partial first mesh patterns P1, as shown by the profile in dashed lines in FIG. 2A. Each of the connection portions 224 is constituted by parts of the first mesh patterns P1 and is shaped as a letter H (shown by the one-dot chain lines in FIG. 2B). Here, the long sides (the line segment extended along the first direction D1) of the H-like connection portions 224 are bent shaped; however, the shape of the first sub-units 222 and the connection portions 224 is not limited in the invention. In another embodiment, the shape of the first sub-units 222 and the connection portions 224 may be determined according to actual design requirements.

The second touch-sensing units 230 are electrically insulated from each other or one another and electrically insulated from the first touch-sensing units 220. Besides, each of the second touch-sensing units 230 includes a plurality of second sub-units 232 and a plurality of bridge structures 234, two adjacent second sub-units 232 are serially connected by the bridge structures 234 along the first direction D1, and the bridge structures 234 of the second touch-sensing units 230 described herein intersect the connection portions 224 of the first touch-sensing units 220.

Each of the second sub-units 232 includes a plurality of second mesh patterns P2 connected together, and the shape of each second mesh pattern P2 may be the same as the shape described in the previous embodiment. For instance, each of the second mesh patterns P2 may be shaped as a hexagon.

In the present embodiment, each second sub-unit 232 is shaped as a rhombus constituted by a plurality of complete second mesh patterns P2 and partial second mesh patterns P2, as shown by the profile in dotted lines in FIG. 2A. However, the shape of each second sub-unit 232 is not limited in the invention. In another embodiment, the shape of the second sub-units 232 may be determined according to actual design requirements.

The second mesh patterns P2 constituting the second sub-units 232 and the first mesh patterns P1 constituting the first sub-units 220 are formed by the same conductive layer, for instance, and the first touch-sensing units 220 are separated from the second sub-units 232 by means of specific pattern design. In particular, the second sub-units 232, the first touch-sensing units 220, the bonding pads that are not shown, and the traces that are not shown are formed by the same conductive layer. The material of the conductive layer exemplarily includes copper, silver, aluminum, chromium, titanium, molybdenum, or an alloy having at least two of the above. The bridge structures 234, however, are formed by another conductive layer. The bridge structures 234 may also be made of the same material as that of said conductive layer and is thus characterized by favorable conductivity.

Since the first touch-sensing units 220 and the second sub-units 232 described herein are made of the same material as that of the conductive layer other than ITO, the first touch-sensing units 120 and the second sub-units 232 are not only characterized by favorable conductivity but also able to be patterned together with the bonding pads (not shown) and the traces (not shown). Thereby, the overall manufacture of the touch panel 200 may be simplified. Moreover, the material of the conductive layer is employed to make the first mesh patterns P1 and the second mesh patterns P2 in the touch panel 200 to replace the transparent conductive material including rare metal (indium), and thus the manufacturing costs of the touch panel 200 described herein may be reduced.

In addition, to reduce the visibility of the profile of each first mesh pattern P1 and the profile of each second mesh pattern P2 to human eyes, the line width LP1 of each of the first mesh patterns P1 described in the present embodiment is equal to or smaller than 20 micrometers, and so is the line width LP2 of each of the second mesh patterns P2, for instance. Besides, in consideration of the conductivity and the stress of the first mesh patterns P1 and the second mesh patterns P2, the thickness DP1 of each of the first mesh patterns P1 and the thickness DP2 of each of the second mesh patterns P2 substantially range from 10 nanometers to 15 micrometers, for instance.

The insulation layer 240 is located between the conductive layer (containing the second mesh patterns P2 and the first mesh patterns P1) and the bridge structures 234, such that the second touch-sensing units 230 are electrically insulated from the first touch-sensing units 220. For instance, the insulation layer 240 may cover the touch area A1 entirely, and two adjacent sub-units 232 are serially connected by the bridge structures 234 along the first direction D1 through contact windows in the insulation layer 240. Alternatively, as provided in the present embodiment, the insulation layer 240 includes a plurality of insulation patterns 242 located between the bridge structures 234 and the connection portions 224.

The insulation patterns 242 are overlapped with the bridge structures 234, and a line width L242 of each of the insulation patterns 242 is greater than the line width LP1 of each of the first mesh patterns P1 and a line width L234 of each of the bridge structures 234. According to the present embodiment, the line width L234 of each of the bridge structures 234 may be smaller than the line width LP1 of each of the first mesh patterns P1.

Besides, each of the bridge structures 234 described herein may be overlapped with at least one part of one of the connection portions 224; that is, the bridge structures 234 may not be completely overlapped with the connection portions 224. Each of the bridge structures 234 is extended to the two adjacent second sub-units 232 from one of the insulation patterns 242, so as to serially connect the two adjacent second sub-units 232 along the first direction D1. In the present embodiment, the profile of each insulation pattern 232 and the profile of each bridge structure 234 are bent corresponding to the first mesh patterns P1 overlapped therewith, and each bridge structure 234 is overlapped with one part of one of the connection portions 224; however, the invention is not limited thereto. In another embodiment, the bridge structures 234 may be completely overlapped with the connection portions 224 and thereby form the H-like patterns.

Due to the high reflectivity of the first mesh patterns P1 and the second mesh patterns P2 made of metal, light is apt to be reflected in the region where the first mesh patterns P1 and the second mesh patterns P2 are located, which accordingly poses a negative impact on the visual effects of the touch panel 200. For instance, bright spots may be observed in the region where the first mesh patterns P1 and the second mesh patterns P2 are located, or the visible color aberration between the colored first and second mesh patterns P1 and P2 (with high reflectivity) and the substrate 110.

To resolve the issue of high reflectivity in the region where the first mesh patterns P1 and the second mesh patterns P2 are located, the first optical mesh patterns O1 and the second optical mesh patterns O2 are overlapped with the first mesh patterns P1 and the second mesh patterns P2 and are respectively located on a surface of the first mesh patterns P1 and a surface of the second mesh patterns P2 adjacent to the user. Here, the thickness DO1 of the first optical mesh patterns O1 and the thickness DO2 of the second optical mesh patterns O2 respectively range from 3 nanometers to 500 nanometers, for instance.

In the present embodiment, a surface S2 of the substrate 210 opposite to the surface S1 is a touch surface of the touch panel 200, for instance. Hence, the first optical mesh patterns O1 described herein are located between the first mesh patterns P1 and the substrate 210, and the second optical mesh patterns O2 described herein are located between the second mesh patterns P2 and the substrate 210, for instance. In another embodiment, if the surface S1 is the touch surface, the first optical mesh patterns O1 and the second optical mesh patterns O2 are respectively located on one side of the first mesh patterns P1 and on one side of the second mesh patterns P2 away from the substrate 210, i.e., the first mesh patterns P1 are located between the first optical mesh patterns O1 and the substrate 210, and the second mesh patterns P2 are located between the second optical mesh patterns O2 and the substrate 210.

In the present embodiment, the profile of each of the first optical mesh patterns O1 is substantially the same as the profile of each of the first mesh patterns P1, and the profile of each of the second optical mesh patterns O2 is substantially the same as the profile of each of the second mesh patterns P2. Hence, there are gaps G between the second optical mesh patterns O2 and the first optical mesh patterns O1. Additionally, the line width LO1 of each of the first optical mesh patterns O1 is substantially the same as the line width LP1 of each of the first mesh patterns P1, and the line width LO2 of each of the second optical mesh patterns O2 is substantially the same as the line width LP2 of each of the second mesh patterns P2, for instance. The sidewall of each of the first optical mesh patterns O1 is aligned to the sidewall of each of the first mesh patterns P1, and the sidewall of each of the second optical mesh patterns O2 is aligned to the sidewall of each of the second mesh patterns P2, for instance. However, the invention is not limited thereto.

In another embodiment of the invention, the visibility of the first mesh patterns P1 and the second mesh patterns P2 to human eyes alone a side-view direction may be reduced by properly changing the line width LO1 of each of the first optical mesh patterns O1 and/or the line width LO2 of each of the second optical mesh patterns O2, e.g., by modifying the line width LO1 of each of the first optical mesh patterns O1 to be greater than the line width LP1 of each of the first mesh patterns P1 and/or by modifying the line width LO2 of each of the second optical mesh patterns O2 to be greater than the line width LP2 of each of the second mesh patterns P2. The visibility of the first mesh patterns P1 and the second mesh patterns P2 to human eyes along the side-view direction may also be reduced by adjusting the thickness DO1 of each of the first optical mesh patterns O1 and the thickness DO2 of each of the second optical mesh patterns O2.

The material of the first optical mesh patterns O1 described herein may be referred to as that of the first optical mesh patterns described in the first embodiment. In addition, the method of forming the first optical mesh patterns O1, the first mesh patterns P1, the second optical mesh patterns O2, and the second mesh patterns P2 in the present embodiment may be referred to as the method of forming the optical mesh patterns and the mesh patterns described in the first embodiment and therefore will not be further explained hereinafter.

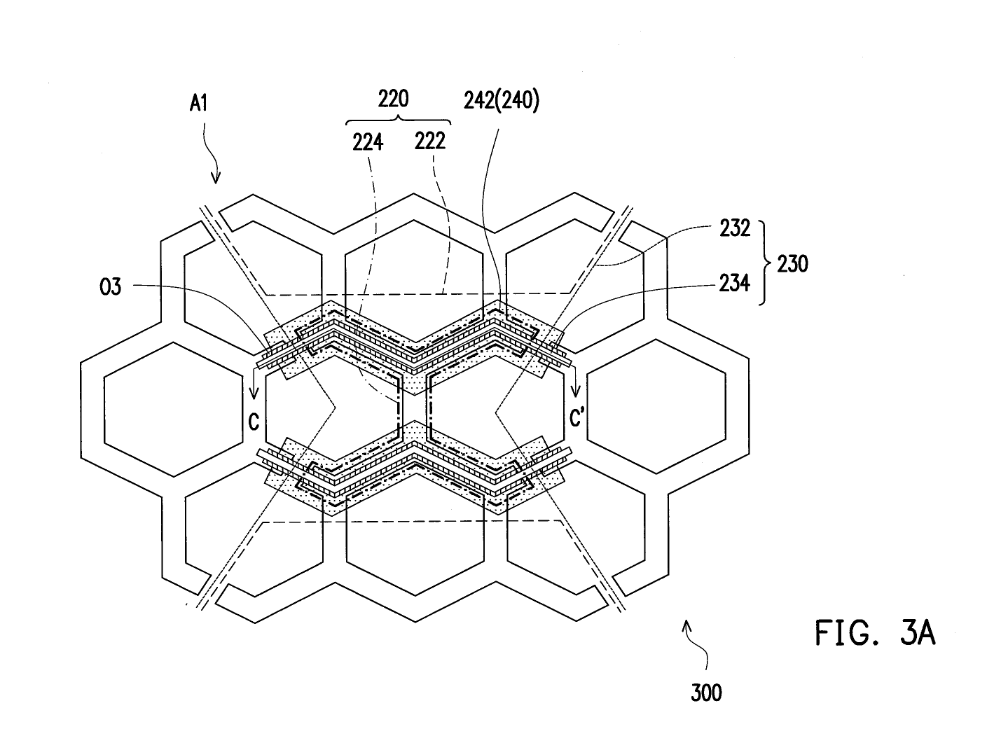

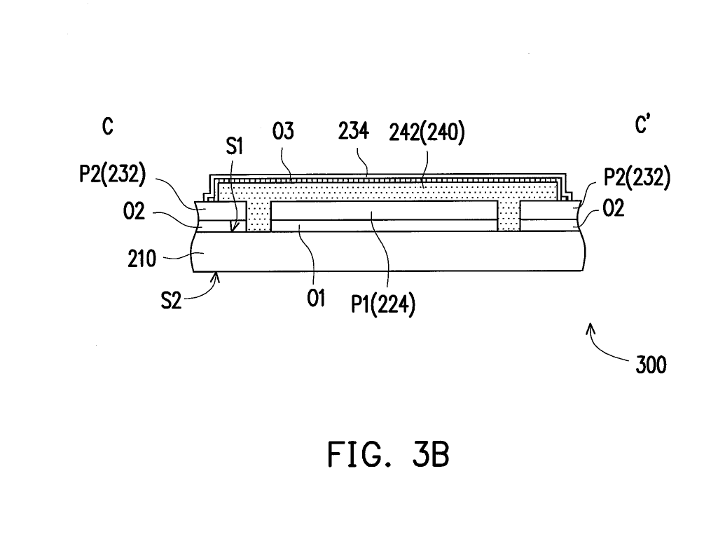

FIG. 3A is a schematic partial top view illustrating a touch panel according to a third embodiment of the invention. FIG. 3B is a schematic cross-sectional view taken along a sectional line C-C′ in FIG. 3A. With reference to FIG. 3A and FIG. 3B, the components as well as their relative arrangements, thicknesses, line widths, and materials described in the touch panel 300 are similar to those provided in the touch panel 200 shown in FIG. 2A to FIG. 2C. The difference between the touch panel 300 described herein and the touch panel 200 mainly lies in that the touch panel 300 further includes a plurality of optical bridge patterns O3 located in the touch area A1. The optical bridge patterns O3 are overlapped with the bridge structures 234 and located between the bridge structures 234 and the first mesh patterns O1.

In the present embodiment, the profile of each of the optical bridge patterns O3 is substantially the same as the profile of each of the bridge structures 234, the profile of each of the first optical mesh patterns O1 is substantially the same as the profile of each of the first mesh patterns P1, and the profile of each of the second optical mesh patterns O2 is substantially the same as the profile of each of the second mesh patterns P2. Thereby, in the present embodiment, the issue of high reflectivity in the region where the first mesh patterns P1, the second mesh patterns P2, and the bridge structures 234 are located may be resolved, and the resultant touch panel 300 may achieve outstanding visual effects.

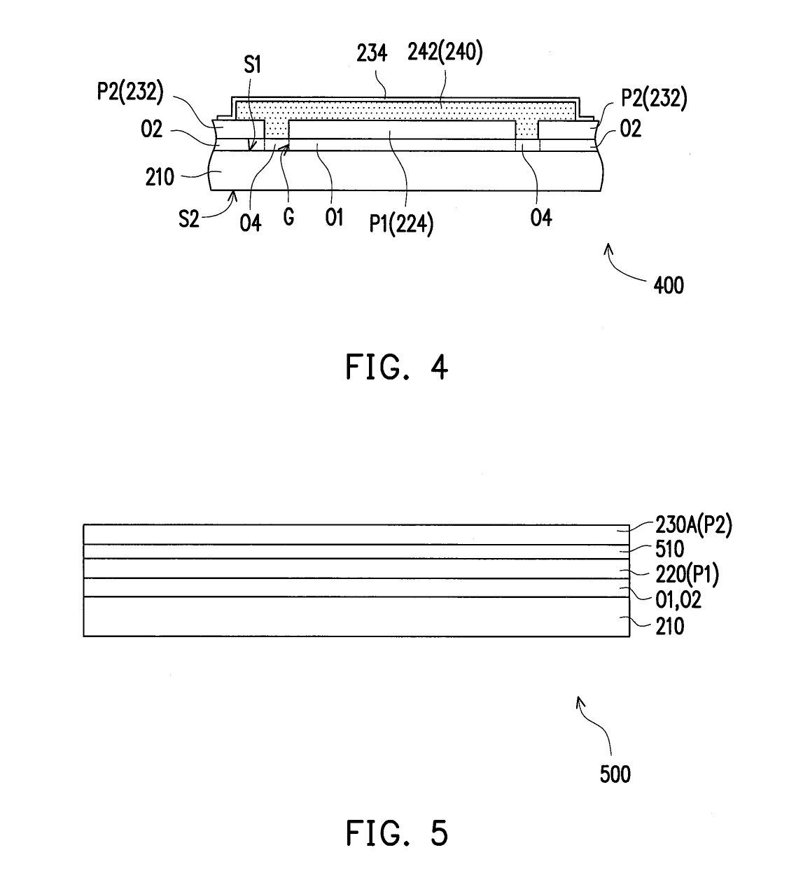

FIG. 4 is a schematic partial cross-sectional view illustrating a touch panel according to a fourth embodiment of the invention. With reference to FIG. 4, the components as well as their relative arrangements, thicknesses, line widths, and materials described in the touch panel 400 are similar to those provided in the touch panel 200 shown in FIG. 2A to FIG. 2C. The difference between the touch panel 400 described herein and the touch panel 200 mainly lies in that the touch panel 400 further includes a plurality of optical connection patterns O4 located on a plane where the first optical mesh patterns O1 and the second optical mesh patterns O2 are located, and the optical connection patterns O4 are located in the gaps G between the first optical mesh patterns O1 and the second optical mesh patterns O2, such that an overall profile of the first optical mesh patterns O1, the second optical mesh patterns O2, and the optical connection patterns O4 substantially corresponds to an overall profile of the first mesh patterns P1, the second mesh patterns P2, and the bridge structures 234. To be specific, orthogonal projections of the first mesh patterns P1, the second mesh patterns P2, and the bridge structures 234 on the substrate 210 are overlapped with orthogonal projections of the first optical mesh patterns O1, the second optical mesh patterns O2, and the optical connection patterns O4 on the substrate 210. Here, the orthogonal projections of the optical connection patterns O4 on the substrate 210 may be larger than or equal to the orthogonal projections of the bridge structures 234 on the substrate 210. Thanks to said design, the issue of high reflectivity in the region where the first mesh patterns P1, the second mesh patterns P2, and the bridge structures 234 are located may be resolved, and the resultant touch panel 400 may achieve outstanding visual effects.

According to the second, the third, and the fourth embodiments, the connection portions 224 are located between the bridge structures 234 and the first optical mesh patterns O1, i.e., the conductive layer containing the first touch-sensing units, the second sub-units, the bonding pads, and the traces is formed before the bridge structures are formed. Nevertheless, in another embodiment, the bridge structures may be formed before the conductive layer is formed. That is, the bridge structures 234 are located between the connection portions 224 and the first optical mesh patterns O1.

Besides, in the first, the second, the third, and the fourth embodiments, the mesh patterns and the optical mesh patterns are directly formed on the substrate, which should however not be construed as a limitation to the invention. Other embodiments of the touch panel are provided below with reference to FIG. 5 to FIG. 7.

FIG. 5 is a schematic partial cross-sectional view illustrating a touch panel according to a fifth embodiment of the invention. With reference to FIG. 5, the components as well as their relative arrangements, thicknesses, line widths, and materials described in the touch panel 500 are similar to those provided in the touch panel 200 shown in FIG. 2A to FIG. 2C. The difference between the touch panel 500 and the touch panel 200 mainly lies in that the touch panel 500 described in the present embodiment further includes a first insulation base material 510 that is located on the first touch-sensing units 220. Besides, the second touch-sensing units 230A of the touch panel 500 are located on the first insulation base material 510 and comprised of the second mesh patterns P2 connected together. Particularly, in the present embodiment, each of the second touch-sensing units 230A includes a plurality of second sub-units and a plurality of second connection portions by which two adjacent second sub-units are serially connected along the first direction. Here, the second sub-units and the second connection portions are integrally formed and patterned through one etching process, for instance. Besides, the second connection portions are overlapped with the connection portions of the first touch-sensing units 220.

According to the present embodiment, the second optical mesh patterns O2 are located on the plane where the first optical mesh patterns O1 are located, for instance. In addition, the overall profile of the first optical mesh patterns O1 and the second optical mesh patterns O2 is substantially the same as the overall profile of the first mesh patterns P1 and the second mesh patterns P2. Specifically, orthogonal projections of the first mesh patterns P1 and the second mesh patterns P2 on the substrate 210 are overlapped with orthogonal projections of the first optical mesh patterns O1 and the second optical mesh patterns O2 on the substrate 210. Here, the orthogonal projections of the first optical mesh patterns O1 and the second optical mesh patterns O2 on the substrate 210 may be larger than or equal to the orthogonal projections of the first mesh patterns P1 and the second mesh patterns P2 on the substrate 210. Thanks to said design, the issue of high reflectivity in the region where the first mesh patterns P1 and the second mesh patterns P2 are located may be resolved, and the resultant touch panel 500 may achieve outstanding visual effects.

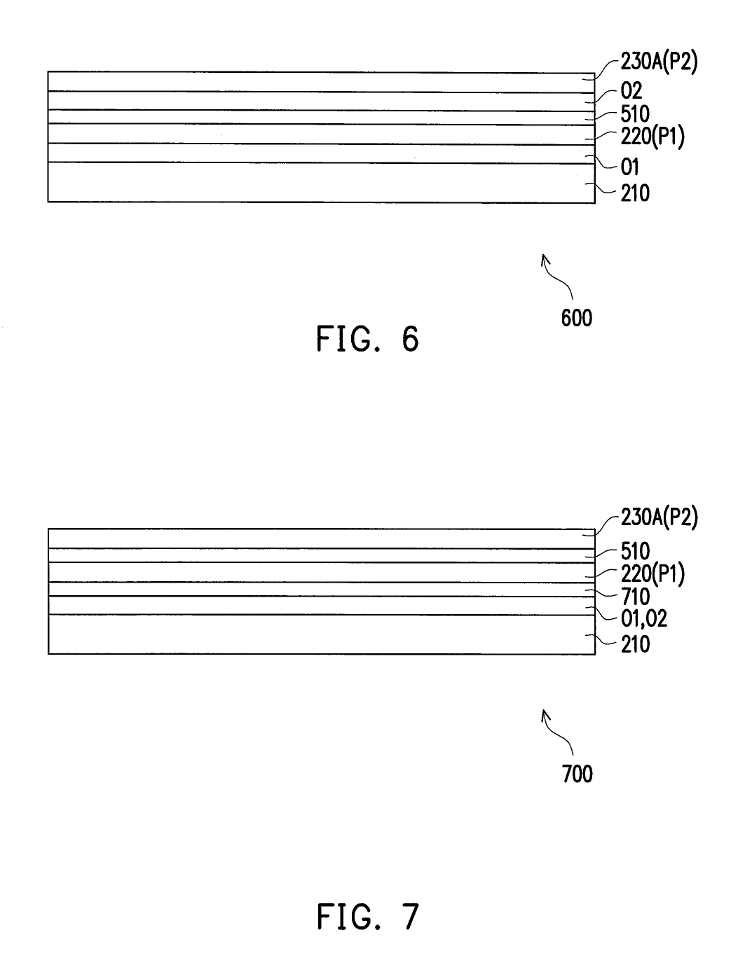

FIG. 6 is a schematic partial cross-sectional view illustrating a touch panel according to a sixth embodiment of the invention. With reference to FIG. 6, the components as well as their relative arrangements described in the touch panel 600 are similar to those provided in the touch panel 500 shown in FIG. 5. The difference between the touch panel 600 and the touch panel 500 mainly lies in that the second optical mesh patterns O2 of the touch panel 600 are located between the second touch-sensing units 230A and the first insulation base material 510, the profile of each of the second optical mesh patterns O2 is substantially the same as the profile of each of the second mesh patterns P2, and the profile of each of the first optical mesh patterns O1 is substantially the same as the profile of each of the first mesh patterns P 1. Specifically, orthogonal projections of the second mesh patterns P2 on the first insulation base material 510 are overlapped with orthogonal projections of the second optical mesh patterns O2 on the first insulation base material 510, and orthogonal projections of the first mesh patterns P1 on the substrate 210 are overlapped with orthogonal projections of the first optical mesh patterns O1 on the substrate 210. Here, the orthogonal projections of the second mesh patterns P2 on the first insulation base material 510 may be larger than or equal to the orthogonal projections of the second optical mesh patterns O2 on the first insulation base material 510, and the orthogonal projections of the first optical mesh patterns O1 on the substrate 210 may be larger than or equal to the orthogonal projections of the first mesh patterns P1 on the substrate 210. Thanks to said design, the issue of high reflectivity in the region where the first mesh patterns P1 and the second mesh patterns P2 are located may be resolved, and the resultant touch panel 600 may achieve outstanding visual effects.

FIG. 7 is a schematic partial cross-sectional view illustrating a touch panel according to a seventh embodiment of the invention. With reference to FIG. 7, the components as well as their relative arrangements described in the touch panel 700 are similar to those provided in the touch panel 500 shown in FIG. 5. The difference between the touch panel 700 and the touch panel 500 mainly lies in that the touch panel 700 further includes a second insulation base material 710 that is located between the first mesh patterns P1 and the substrate 210. Particularly, the first optical mesh patterns O1 and the second optical mesh patterns O2 described herein are formed on the substrate 210, for instance. In another embodiment of the invention, the first optical mesh patterns O1 and the second optical mesh patterns O2 may be formed on the second insulation base material 710, and the second insulation base material 710 is adhered to the substrate 210 by an adhesive layer. Alternatively, the second optical mesh patterns O2 described herein may be applicable to the structure described in the sixth embodiment (i.e., the second optical mesh patterns O2 are formed on the first insulation base material 510), and the first optical mesh patterns O1 are formed on the second insulation base material 710 or on the substrate 210. Thanks to said design, the issue of high reflectivity in the region where the first mesh patterns P1 and the second mesh patterns P2 are located may be resolved, and the resultant touch panel 700 may achieve outstanding visual effects.

To sum up, the optical mesh patterns overlapped with the mesh patterns are configured on the surface of the mesh patterns adjacent to the user, so as to resolve the bright spot issue, the color aberration issue, or other issues of high reflectivity along the view direction in the region where the mesh patterns are located. Thereby, the touch panel described herein is able to accomplish the outstanding visual effects.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch panel comprising:
a substrate;
a plurality of first touch-sensing unit electrically insulated from each other or one another and located on the substrate, wherein each of the first touch-sensing unit comprises a plurality of first mesh patterns connected together; and
a plurality of first optical mesh patterns located on the substrate, the first optical mesh patterns being overlapped with the first mesh patterns and located on a surface of the first mesh patterns adjacent to a user.

2. The touch panel as recited in claim 1, wherein the substrate comprises a touch area and a peripheral area located around the touch area, the first touch-sensing units are located in the touch area, and the touch panel further comprises:
a plurality of bonding pads located on the substrate and in the peripheral area;
a plurality of traces located on the substrate and in the peripheral area, the first touch-sensing units being electrically connected to the bonding pads through the traces.

3. The touch panel as recited in claim 2, wherein the first touch-sensing units, the traces, and the bonding pads are formed by one conductive layer, and a material of the conductive layer comprises copper, silver, aluminum, chromium, titanium, molybdenum, or an alloy having at least two of the above.

4. The touch panel as recited in claim 1, wherein the first optical mesh patterns are located between the first mesh patterns and the substrate.

5. The touch panel as recited in claim 1, wherein a material of the first optical mesh patterns comprises copper oxide, chromium oxide, titanium oxide, molybdenum oxide, or a stacked layer having at least two of the above.

6. The touch panel as recited in claim 1, wherein a material of the first optical mesh patterns comprises titanium dioxide, silicon oxide, silicon nitride, silicon oxynitride, silicon aluminum oxide, or a stacked layer having at least two of the above, and a refractive index of the first optical mesh patterns substantially ranges from 1.6 to 2.4.

7. The touch panel as recited in claim 1, wherein a material of the first optical mesh patterns comprises chromium, nickel, molybdenum, titanium, or an alloy having at least two of the above.

8. The touch panel as recited in claim 1, wherein a material of the first optical mesh patterns comprises a resin light-absorption material or a carbon-black paint.

9. The touch panel as recited in claim 1, wherein a thickness of the first mesh patterns substantially ranges from 10 nanometers to 15 micrometers.

10. The touch panel as recited in claim 1, wherein a thickness of the first optical mesh patterns substantially ranges from 3 nanometers to 500 nanometers.

11. The touch panel as recited in claim 1, wherein a line width of each of the first mesh patterns is equal to or smaller than 20 micrometers.

12. The touch panel as recited in claim 1, wherein a profile of each of the first optical mesh patterns is substantially the same as a profile of each of the first mesh patterns.

13. The touch panel as recited in claim 1, wherein a line width of each of the first optical mesh patterns is greater than or equal to a line width of each of the first mesh patterns.

14. The touch panel as recited in claim 13, wherein the line width of each of the first optical mesh patterns is greater than the line width of each of the first mesh patterns, and the first optical mesh patterns cover the first mesh patterns.

15. The touch panel as recited in claim 1, wherein the first touch-sensing units are arranged along a first direction and individually extended along a second direction, the second direction intersects the first direction, each of the first touch-sensing units comprises a plurality of first sub-units and a plurality of connection portions, two adjacent first sub-units of the first sub-units are serially connected by the connection portions along the second direction, and the touch panel further comprises:
a plurality of second touch-sensing units electrically insulated from the first touch-sensing units, each of the second touch-sensing units comprising a plurality of second sub-units and a plurality of bridge structures, two adjacent second sub-units of the second sub-units being serially connected by the bridge structures along the first direction, each of the second sub-units comprising a plurality of second mesh patterns connected together, the second mesh patterns and the first mesh patterns being formed by one conductive layer, the first touch-sensing units being separated from the second sub-units;
an insulation layer located between the conductive layer and the bridge structures; and
a plurality of second optical mesh patterns overlapped with the second mesh patterns and located on a surface of the second mesh patterns adjacent to the user.

16. The touch panel as recited in claim 15, wherein the bridge structures of the second touch-sensing units intersect the connection portions of the first touch-sensing units, and the insulation layer comprises a plurality of insulation patterns located between the bridge structures and the connection portions.

17. The touch panel as recited in claim 16, wherein each of the bridge structures is overlapped with at least one part of one of the connection portions, the insulation patterns are overlapped with the bridge structures, and a line width of each of the insulation patterns is greater than a line width of each of the first mesh patterns and a line width of each of the bridge structures.

18. The touch panel as recited in claim 15, wherein a line width of each of the bridge structures is smaller than a line width of each of the first mesh patterns.

19. The touch panel as recited in claim 15, wherein a plurality of gaps are located between the second optical mesh patterns and the first optical mesh patterns, the touch panel further comprises a plurality of optical connection patterns located on a plane where the first optical mesh patterns and the second optical mesh patterns are located, and the optical connection patterns are located in the gaps, such that an overall profile of the first optical mesh patterns, the second optical mesh patterns, and the optical connection patterns substantially corresponds to an overall profile of the first mesh patterns, the second mesh patterns, and the bridge structures.

20. The touch panel as recited in claim 15, wherein the connection portions are located between the bridge structures and the first optical mesh patterns.

21. The touch panel as recited in claim 15, wherein the bridge structures are located between the connection portions and the first optical mesh patterns.

22. The touch panel as recited in claim 15, wherein a shape of each of the first mesh patterns or a shape of each of the second mesh patterns comprises a circular shape, a polygonal shape, a sine-wave shape, a curve, or a combination of two of the above.

23. The touch panel as recited in claim 15, further comprising:
a plurality of optical bridge patterns overlapped with the bridge structures and located between the bridge structures and the first mesh patterns, a profile of each of the optical bridge patterns being substantially the same as a profile of each of the bridge structures, a profile of each of the first optical mesh patterns being substantially the same as a profile of each of the first mesh patterns, a profile of each of the second optical mesh patterns being substantially the same as a profile of each of the second mesh patterns.

24. The touch panel as recited in claim 1, wherein the first touch-sensing units are arranged along a first direction and individually extended along a second direction, the second direction intersects the first direction, and the touch panel further comprises:
a first insulation base material located on the first touch-sensing units;
a plurality of second touch-sensing units located on the first insulation base material, the second touch-sensing units being extended along the first direction and arranged along the second direction, each of the second touch-sensing units comprising a plurality of second mesh patterns connected together; and
a plurality of second optical mesh patterns overlapped with the second mesh patterns and separated from the first optical mesh patterns.

25. The touch panel as recited in claim 24, wherein the second optical mesh patterns are located on a plane where the first optical mesh patterns are located, and an overall profile of the first optical mesh patterns and the second optical mesh patterns is substantially the same as an overall profile of the first mesh patterns and the second mesh patterns.

26. The touch panel as recited in claim 24, wherein the second optical mesh patterns are located between the second touch-sensing units and the first insulation base material, a profile of each of the second optical mesh patterns is substantially the same as a profile of each of the second mesh patterns, and a profile of each of the first optical mesh patterns is substantially the same as a profile of each of the first mesh patterns.

27. The touch panel as recited in claim 24, further comprising:
a second insulation base material located between the first mesh patterns and the substrate.

28. The touch panel as recited in claim 1, wherein a material of the first optical mesh patterns is an oxide of a material of the first mesh patterns.

29. The touch panel as recited in claim 1, wherein the substrate is a cover lens and comprises a touch area and a peripheral area located around the touch area, the first touch-sensing units are located in the touch area, and the touch panel further comprises:
a decoration layer located in the peripheral area.

30. The touch panel as recited in claim 1, wherein the substrate is a color filter substrate of a liquid crystal display.

31. The touch panel as recited in claim 1, wherein the substrate is an encapsulation cover plate of an organic light-emitting diode.

32. A touch panel comprising:
a substrate;
a plurality of first optical mesh patterns located on the substrate; and
a plurality of first touch-sensing units electrically insulated from each other or one another and located on the substrate, each of the first touch-sensing units comprising a plurality of first mesh patterns overlapped with the first optical mesh patterns and at least one first mesh pattern not overlapped with the first optical mesh patterns, wherein the first optical mesh patterns are located on a surface of the first mesh patterns adjacent to a user.
